(19) United States
(12) Patent Application Publication
(10) Pub. No.: US 2026/0309123 A1
(43) Pub. Date: Oct. 8, 2026

(54) A METHOD FOR MOUNTING A WIND TURBINE ROTOR BLADE TO A HUB

(71) Applicant: Vestas Wind Systems A/S, Aarhus N. (DK)

(72) Inventors: Vignesh Sundaramoorthy, Chennai (IN); Balachandar Mahalingam, Coimbatore (IN); Payam Javadian, Aarhus N (DK); Jose Henrique Vaz Neves Miranda Lopes, Vila Nova Gaia (PT)

(73) Assignee: Vestas Wind Systems A/S, Aarhus N. (DK)

(21) Appl. No.: 19/481,954

(22) PCT Filed: Apr. 30, 2024
(86) PCT No.: PCT/DK2024/050095

§ 371 Date: Nov. 6, 2025

(30) Foreign Application Priority Data
May 10, 2023 (DK) PA202370226

(51) Int. Cl. F03D 1/06; F03D 13/10

(52) U.S. Cl. CPC F03D 1/066; F03D 13/108; F05B 2230/608; F05B 2230/61; F05B 2240/221

(57) ABSTRACT

The invention provides a method for mounting a wind turbine rotor blade (11) to a hub (18),—the blade comprising a blade root (111) comprising a root shell (115) forming a tubular shape of the blade root, the blade root forming an open blade root end (112) defining an imaginary root end plane (REP) at which the root shell terminates,—wherein for mounting the blade (11) to the hub (18), one of the blade root and the hub comprises a plurality of protruding engagement devices (119), and the other of the blade root and the hub forms a plurality of engagement apertures (181) each arranged to receive a respective of the engagement devices (119),—wherein the method comprises placing in the blade root (111), before the blade is mounted to the hub, a jacking device (401) so as to extend between two opposite locations of the blade root shell (115),—extending the jacking device (401) to subject the blade root (111) to a jacking force acting on said two locations (401L) of the root shell (115), so as to alter the shape of the blade root as seen in a direction which is perpendicular to the root end plane (REP), and—subsequently to said step of extending the jacking device (401), and while the jacking device is extended to subject the blade root (111) to the jacking force, moving the blade (11) and/or hub (18) to allow the engagement devices (119) to at least partly enter the respective engagement apertures (181).

### TECHNICAL FIELD

The present invention relates to a method for mounting a wind turbine rotor blade to a rotor hub.

### BACKGROUND

A horizontal axis wind turbine is known to have an electric generator in a nacelle on top of a tower, where a rotor, with one or more blades, with a substantially horizontal axis, is mounted to the nacelle and arranged to drive the generator.

Due to large blade sizes of modern wind turbines, there may be problems with blade root ovalization before the blades are installed on the hubs. The ovalization may be caused by plastic deformation of the blade roots, e.g. after the blade manufacturing, for example due to resin in the fiber composite materials of the blades not yet being fully cured. This may in turn cause problems with misalignment between engagement holes on the hubs, and protruding engagement devices, such as studs or threaded pins, on the blades.

EP2453129 suggests providing a blade with guiding bushings with extensions with decreasing outer diameters and complementary recesses on the hub. However, the diameter of the recesses provides a limit to the degree of misalignment that can be corrected.

### SUMMARY OF THE INVENTION

The present invention aims to provide an improved way of addressing the problem of misalignment between protruding engagement devices and engagement apertures when mounting blades to a wind turbine hub.

This object of the invention is reached with a method according to claim 1. Thus, the invention provides a method for mounting a wind turbine rotor blade to a hub,
the blade comprising a blade root comprising a root shell forming a tubular shape of the blade root, the blade root forming an open blade root end defining an imaginary root end plane at which the root shell terminates,
wherein for mounting the blade to the hub, one of the blade root and the hub comprises a plurality of protruding engagement devices, and the other of the blade root and the hub forms a plurality of engagement apertures each arranged to receive a respective of the engagement devices,
wherein the method comprises placing in the blade root, before the blade is mounted to the hub, a jacking device so as to extend between two opposite locations of the blade root shell,
extending the jacking device to subject the blade root to a jacking force acting on said two locations of the root shell, so as to alter the shape of the blade root as seen in a direction which is perpendicular to the root end plane, and
subsequently to said step of extending the jacking device, and while the jacking device is extended to subject the blade root to the jacking force, moving the blade and/or hub to allow the engagement devices to at least partly enter the respective engagement apertures.

In some embodiments, the blade comprises the protruding engagement devices, and the engagement apertures are formed by a blade mounting flange of the hub. The mounting flange may be a ring of a blade pitch bearing. The engagement devices may protrude from a surface of the blade root end. The blade root end may coincide with the root end plane. In some embodiments, the hub comprises the protruding engagement devices, and the engagement apertures are formed by the blade.

The jacking device may be placed in the blade root before the jacking device is extended. An inner space of the blade root may communicate with the surrounding atmosphere. The jacking device may be placed in the inner space of the blade root. The jacking device may be placed so as to extend substantially in parallel with the root end plane. The jacking device may be placed transversely to a blade longitudinal direction. The jacking device may be placed so as to extend across the blade root inner space. The two opposite locations between which the jacking device extends may be on an inner surface of the blade root shell.

The extension of the jacking device may alter the cross-sectional shape of the blade root. The alteration may start from a shape influenced by a plastic deformation that occurred after manufacturing and before blade installation. The alteration may provide a substantial circular blade root cross-section. The blade and/or hub may be moved to allow the engagement devices to partly or fully enter the respective engagement apertures. Thereby, the engagement devices may become at least partly engaged with the respective engagement apertures.

Where the blade comprises the engagement devices for mounting the blade to the hub, altering, by means of the jacking device extension, the shape of the blade root may change the positions of some of the engagement devices in relation to other of the engagement devices. Similarly, where the blade forms the engagement apertures for mounting the blade to the hub, altering, by means of the jacking device extension, the shape of the blade root may change the positions of some of the engagement apertures in relation to other of the engagement apertures. By such changes of the mutual positions between the engagement devices or apertures, any misalignment of blade engagement devices or apertures in relation to hub engagement apertures or devices, e.g. due to blade root ovalization, may be eliminated.

The shape alteration may involve elastic strains in the blade root. Removing the jacking device before the engagement devices at least partly enter the respective engagement apertures, the elastic strains may cause the blade root to deform, e.g. back to ovalization, so that there will again be misalignments between blade engagement devices or apertures in relation to hub engagement apertures or devices. As opposed to this, keeping the jacking device extended will secure that the alignment of the engagement devices and apertures, provided by the jacking device, is retained until the engagement devices have at least partly entered the respective engagement apertures.

Once the engagement devices have at least partly entered the respective engagement apertures, the jacking device can be removed without problems to the blade installation process. Any tendencies of the blade root to resume a deformed state, e.g. ovalized state, upon the jacking device being removed, will be counteracted by the engagement of the engagement devices with the engagement apertures.

Thereby, the present invention provides an improved way of addressing the problem of misalignment between the engagement devices and engagement apertures.

In some embodiments, the method comprises, subsequently to the engagement devices having at least partly entered the respective engagement apertures, removing the jacking device from the blade root. Thereby, the blade and/or hub may be moved to allow the engagement devices to fully enter the respective engagement apertures, before the jacking device is removed. However, in some embodiments, only portions of the engagement devices enter the respective apertures. Thereby, when the tool is taken out, an undeformed, e.g. circular, blade root cross-sectional shape can be retained by the engagement devices. The blade and/or hub may thereafter be moved so that the engagement devices fully enter the respective apertures. In some embodiments, the jacking device is left in the blade root after the blade installation.

In some embodiments, wherein said jacking device is a first jacking device, said jacking force is a first jacking force, and said locations are first locations, the method comprises
placing in the blade root, before the blade is mounted to the hub, in addition to the first jacking device, a second jacking device so as to extend between two opposite second locations of the blade root shell, and
extending the second jacking device to subject the blade root to a second jacking force acting on said two second locations of the root shell, so as to alter the shape of the blade root as seen in a direction which is perpendicular to the root end plane.

Thereby, the second jacking device is preferably placed so that, as seen in a direction which is perpendicular to the root end plane, the smallest angle between the first jacking device and the second jacking device is more than zero degrees and less than 90 degrees, e.g. more than 10 degrees and less than 40 degrees. Thereby, the first and second jacking devices may, as seen in the direction which is perpendicular to the root end plane, form an X-configuration.

Thereby, the first jacking device may serve to alter the cross-sectional shape of the blade root, and the second jacking device may serve to further alter the cross-sectional shape. In particular when the desired cross-sectional shape of the blade root is circular, by the X-configuration, a deformed blade root may be brought closer to having a circular cross-sectional shape, compared to a case where only one jacking device is used.

The second jacking device is preferably placed so that the second jacking device is offset from the first jacking device in a direction which is perpendicular to the root end plane. The second jacking device is preferably extended to subject the blade root to the second jacking force while the blade and/or hub is moved to allow the engagement devices to at least partly enter the respective engagement apertures.

### BRIEF DESCRIPTION OF THE DRAWINGS

Below examples of the invention will be described in detail with reference to the drawings, in which:

FIG. 1 is a view of a wind turbine,

FIG. 2A is a perspective view of a wind turbine rotor blade,

FIG. 2B is a perspective view of a root of the blade in FIG. 2A,

FIG. 2C is a side view of the blade root in FIG. 2B,

FIG. 3 is a side view of a nacelle of the wind turbine in FIG. 1, at a blade installation method according to an embodiment of the invention,

FIG. 4A illustrates a deformation of the blade root in FIG. 2B,

FIG. 4B is a perspective view of the blade root in FIG. 2B with two jacking devices,

FIG. 4C is a perspective view of one of the jacking devices in FIG. 4B,

FIG. 5 shows a step in the blade installation method, with the wind turbine in FIG. 1 and a crane,

FIG. 6 shows a front view of the nacelle in FIG. 3, and a part of the blade in FIG. 2A,

FIG. 7 shows a front view of a nacelle, and a part of a blade, in a method according to an alternative embodiment of the invention, wherein the blade is shown partly sectioned, and

FIG. 8 is a flow diagram showing steps in the method according to the alternative embodiment of the invention.

### DETAILED DESCRIPTION OF EMBODIMENTS OF THE INVENTION

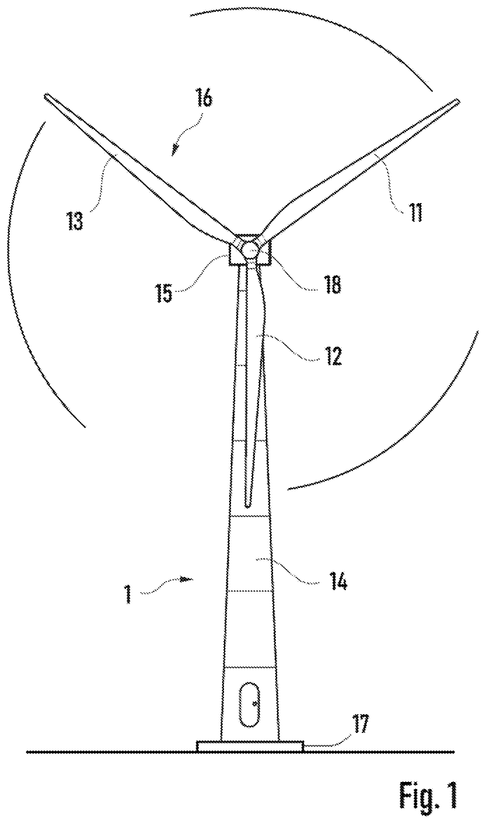

FIG. 1 shows a horizontal axis wind turbine 1. In this example, the wind turbine is an onshore wind turbine. However, the invention is equally applicable to an offshore wind turbine.

The wind turbine 1 comprises a tower 14 supporting a nacelle 15. A rotor 16 is mounted to the nacelle. The tower is supported by a foundation 17. The rotor 16 comprises a plurality of wind turbine blades 11, 12, 13 that extend radially from a central hub 18. In this example, the rotor 16 comprises three blades 11, 12, 13. The hub 18 is mounted to the nacelle 15.

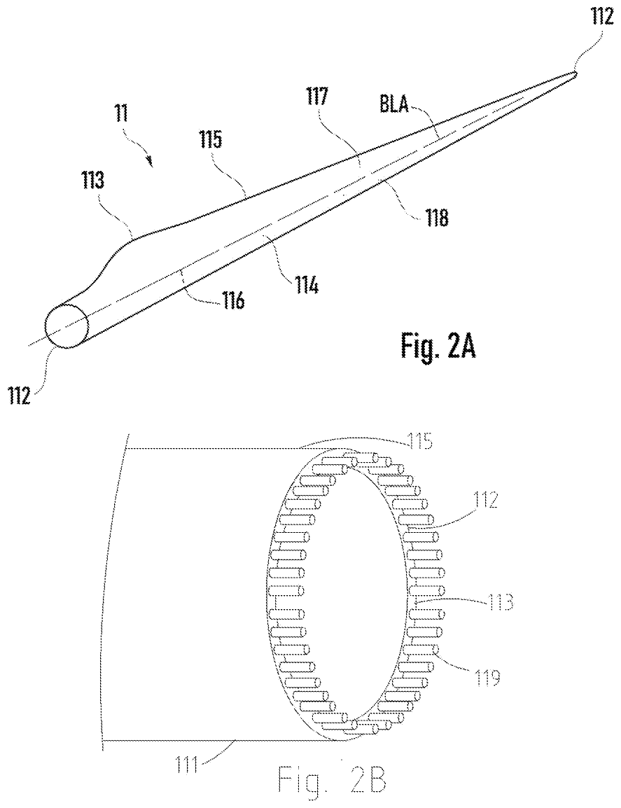

FIG. 2A is a view of one of the blades 11 of the wind turbine 1. The blade 11 extends from a root end 112 to a tip end 112 in a longitudinal ‘spanwise’ direction. A longitudinal axis, or spanwise axis, of the blade is indicated in FIG. 2A with BLA. The root end may be generally circular. The blade may be of any suitable length, e.g. in the interval 30-160 metres. The blade 11 may transition from a circular profile to an airfoil profile moving from the root end 112 of the blade 11 towards a shoulder 113 of the blade 11. The shoulder 113 may be the widest part of the blade 11. The blade 11 may have its maximum chord at the shoulder 113.

It should be noted that the proportions of the blade are provided for easy of understanding, and not necessarily representative of the shape of a wind turbine blade in practice.

The blade 11 extends between a leading edge 114 and a trailing edge 115 in a transverse ‘chordwise’ direction. The blade presents a pressure surface 116 on a pressure side of the blade 11 and a suction surface 117 on a suction side of the blade 11. The blade 11 comprises a shell 118. The shell may be formed primarily of fibre-reinforced composite FRC. The blade may comprise an internal structure. The internal structure may comprise two spar caps and one or more webs.

Reference is made to FIG. 2B and FIG. 2C. The blade root 111 comprises a root shell 115 forming a tubular shape of the blade root. The blade root forms the open blade root end 112 at which the root shell terminates. The root shell 115 is at the root end intended to have a circular cross-sectional shape. In this example, the blade root end 112 is defined by an end surface 113 of the root shell. The end surface 113 is oriented substantially perpendicularly to the longitudinal direction of the blade. The end surface is intended to be circular. As exemplified in FIG. 2C, the end surface 113 defines what is herein referred to as a root end plane REP. Thereby, the root end 112 defines the root end plane REP at which the root shell 115 terminates. In this example, the root end plane is substantially perpendicular to the longitudinal axis BLA of the blade.

A plurality of protruding engagement devices 119 extend from the blade root end. In this example, the engagement devices 119 extend from the end surface 113. The engagement devices extend perpendicularly from the end surface 113. The engagement devices extend substantially in parallel with the blade longitudinal axis BLA. The engagement devices 119 are distributed along the end surface 113. The engagement devices are in this example in the form of pins or studs. Preferably the studs are threaded.

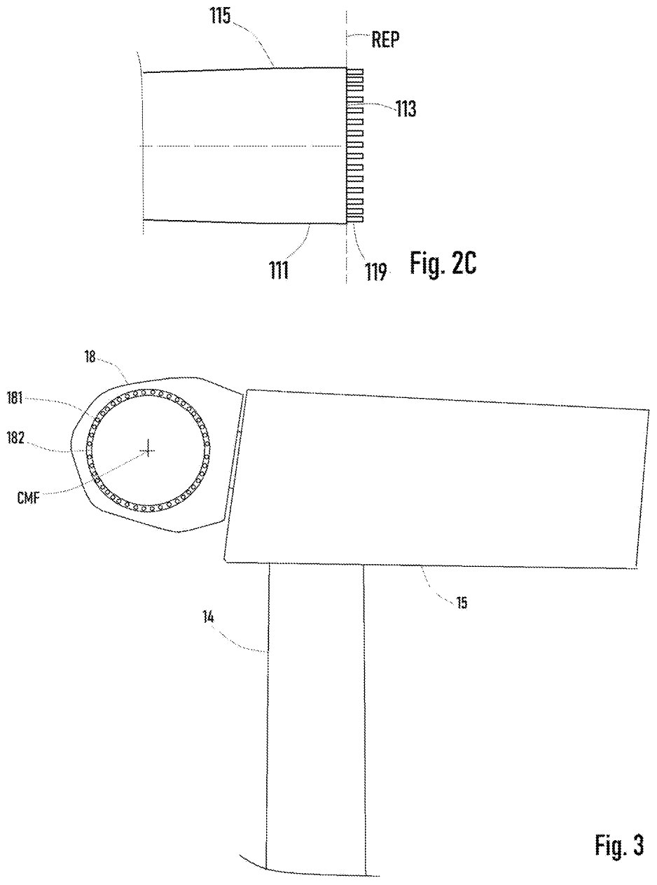

Reference is made also to FIG. 3. The hub 18 forms a plurality of engagement apertures 181 each arranged to receive a respective of the engagement devices 119. The engagement apertures 181 may be through holes in a blade mounting flange 182 of the hub. The blade mounting flange may form, or be fixed to, a bearing ring of a pitch bearing for adjusting the pitch angle of the blade while the wind turbine is in operation. The engagement apertures may be in the form of engage holes 181 distributed along the mounting flange 182 of the hub.

The blade is in this example mounted to the hub by the studs 119 entering the holes 181, so as to extend through the holes. When the end surface 113 of the blade abuts the mounting flange 182 of the hub, end portions of the studs extend into the interior of the hub, and nuts are threaded on the stud end portions to secure the blade to the blade mounting flange.

In alternative embodiments, the hub comprises protruding engagement devices. Thereby, the blade may form a plurality of engagement apertures each arranged to receive a respective of the engagement devices.

Embodiments of the invention provides a method for installation of a blade of a horizontal axis wind turbine. The blade installation may be done while the wind turbine is shut down after having operated to produce power to a grid. Thereby the blade installation may be a part of a service operation. Alternatively, the blade installation may be a part of an installation process of a new wind turbine. The method could be performed onshore. Alternatively, the method may be used for an offshore wind turbine.

Below such an embodiment of the method will be described. The method is used for facilitating blade installation in cases where the blade root has deformed to obtain an oval shape due to plastic deformation at blade storage or transportation. The deformation may for example be, on a blade root with a diameter in the order of magnitude of 4 meters, in the order of magnitude of 5 mm.

The method comprises determining the ovality of the blade root 111. This may be done with a laser measuring device (not shown). For the determination, the measuring device may be fastened to the blade, at the root end 112, e.g. to one of the engagement devices 119. While fastened the measuring device is used to measure the distance to the opposite side of the root end 112. Said measuring steps are repeated a plurality of times, each time with the measuring device fastened at a further of a plurality of locations along the root end 112. These location may be separated in the circumferential direction by a suitable angular distance, e.g. 45 degrees.

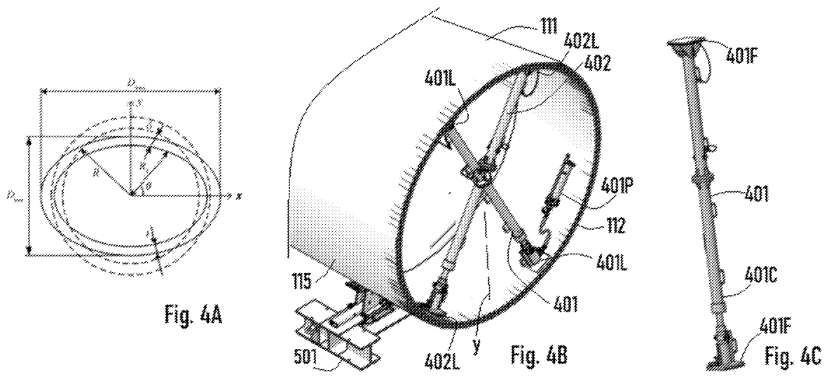

Reference is made to FIG. 4A. Using the measurements, the angular locations of the major and minor axes x, y of an ellipse formed by the blade root end, in relation to a blade fixed coordinate system, are determined. Also, the lengths Dmax, Dmin of the major and minor axes x, y are determined.

As illustrated in FIG. 4B, the method comprises placing in the blade root 111, before the blade is mounted to the hub, a first jacking device 401, and a second jacking device 402. The first jacking device 401 is placed so as to extend between two opposite first locations 401L of the blade root shell 115. The second jacking device 402 is placed so as to extend between two opposite second locations 402L of the blade root shell 115.

The first jacking device 401 is placed to as to be relatively close to the root end 112. (To reduce the among of drawing details, the engagement devices 119 are not shown in FIG. 4B.) For example, the distance between the first jacking device 401 and the root end 112 may be less than 2 meters, preferably less than 1 meter, e.g. about 0.1 meters. The second jacking device 402 is placed so that the second jacking device is offset from the first jacking device 401 in a direction which is perpendicular to the root end plane REP (FIG. 2C).

The jacking devices 401, 402 are placed to as to form an X, as seen in a direction which is perpendicular to the root end plane REP (FIG. 2C). For this, the second jacking device 402 is placed so that, as seen in a direction which is perpendicular to the root end plane, the smallest angle between the first jacking device 401 and the second jacking device 402 is approximately 60 degrees.

Further, the jacking devices 401, 402 are placed so as to mirror each other around the minor axis y of the ellipse formed by the root end 112. Thereby, in this example the jacking devices 401, 402 are in respective angles to the minor axis y of approximately 30 degrees.

One of the jacking devices 401 is shown in FIG. 4C. The jacking device 401 is elongated and comprises feet 401F at its ends, for abutting the inner surface of the root shell. The jacking device further comprises an actuation device, in this embodiment in the form of a hydraulic cylinder 401C.

When the jacking devices 401, 402 have been placed in the blade root 111 (FIG. 4B), they are extended, by means of their actuation devices. For this, where the actuation devices are hydraulic cylinders, they may be pumped manually by levers 401P. Thereby, the blade root is subjected to a first jacking force acting on said two first locations 401L of the root shell 115, and to a second jacking force acting on said two second locations 402L of the root shell 115. The jacking forces will alter the shape of the blade root, so as to become substantially circular, as seen in the direction which is perpendicular to the root end plane. The jacking devices are extended so as to minimize the difference between the lengths Dmax, Dmin of the major and minor axes of the ellipse formed by the blade root. Preferably the jacking devices are extended substantially simultaneously. Thereby, the jacking devices may be extended simultaneously or in alternating partial extension steps.

As suggested in FIG. 4B, the steps of placing the jacking devices, and extending them, are done before the blade is mounted to the hub, e.g. while blade is on the ground, a floor, a ship's deck, e.g. supported by a cradle 501.

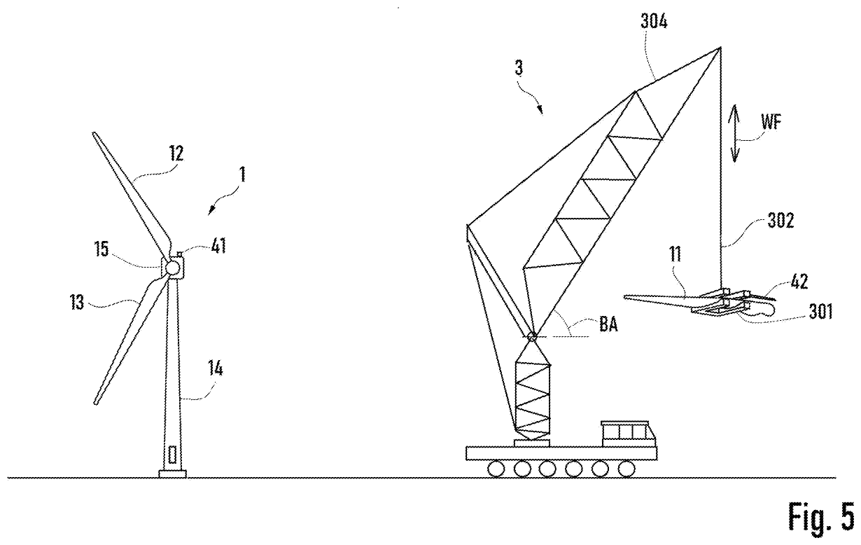

Reference is made also to FIG. 5. In this embodiment, the method comprises supporting the blade 11, with the jacking devices, with lifting means 3. The lifting means 3 may be a crane. The support of the blade by the lifting means 3 may be done by means of a holding device 301 of the lifting means. The holding device may be suspended in one or more wires 302 from a crane boom 304. The holding device 301 may be a device arranged to grip the blade. The holding device may engage the blade in a region between the blade root and the blade tip, e.g. at the shoulder of the blade.

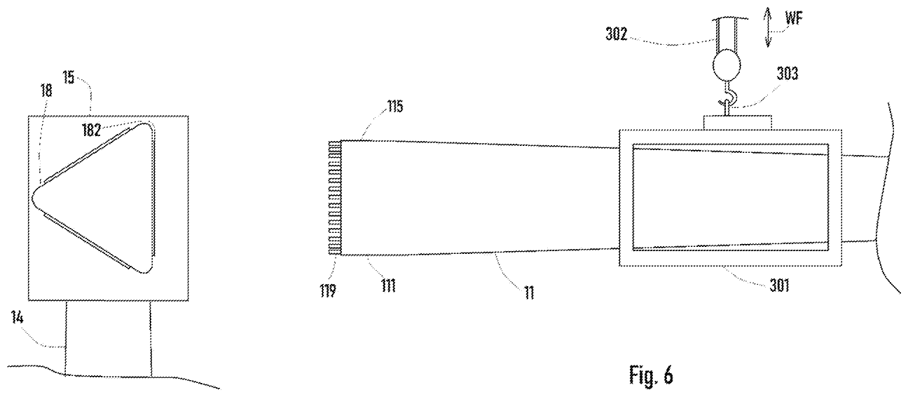

Reference is made also to FIG. 6. For attachment of the blade root to the nacelle hub 18, the blade 11 is held aloft with its longitudinal axis extending substantially horizontally. For mounting the blade, the hub may be positioned around the rotor axis, so that the mounting flange 182 is oriented vertically. The blade 11 is moved to allow the engagement devices 119 to at least partly enter the respective engagement apertures in the mounting flange 182, while the jacking devices 401, 402 (FIG. 4B) are kept extended to subject the blade root to the jacking forces.

Subsequently to the engagement devices 119 having entered the respective engagement apertures, the jacking devices 401, 402 are removed from the blade root 111. This can be done by one or more persons accessing the interior of the blade root from the interior of the hub. The removed jacking devices can for example be moved to the hub, and optionally through the hub and into the nacelle. The jacking devices can for example be hoisted down from the hub or from the nacelle.

It should be noted that in alternative embodiments, the hub is moved to allow the engagement devices of the blade to at least partly enter the respective engagement apertures in the hub. This can be done for example whether the rotor is assembled on the ground, before being installed on the nacelle.

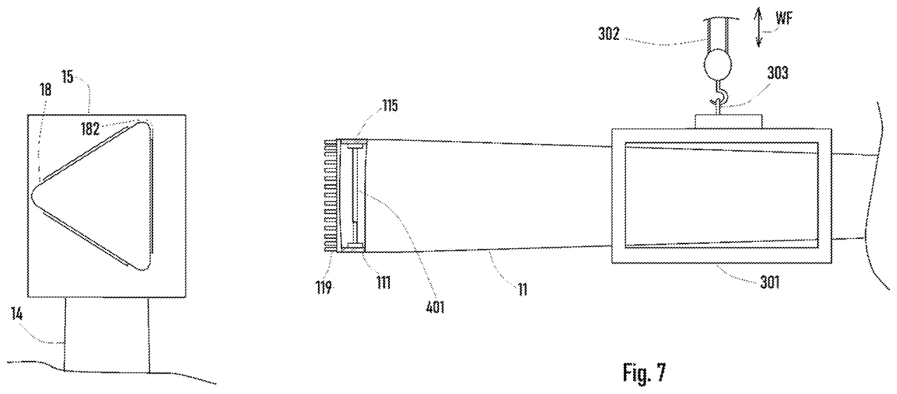

Reference is made to FIG. 7, showing a step in a method according to an alternative embodiment of the invention.

In this embodiment, the method comprises placing in the blade root 111, before the blade is mounted to the hub, a single jacking device 401. The jacking device 401 is placed to as to be relatively close to the root end 112. Further, the jacking device 401 extends substantially along the minor axis y of the ellipse formed by the ovalized root end 112. When the jacking device 401 has been placed in the blade root 111, it is extended, by means of its actuation device. Thereby, the blade root is subjected to a jacking force so as to alter the shape of the blade root, so as to become substantially circular, as seen in the direction which is perpendicular to the root end plane. The steps of placing the jacking device in the blade root, and extending it, may be done before the blade is lifted to the mounted to the hub.

The blade 11 is moved to allow the engagement devices 119 to at least partly enter the respective engagement apertures in the mounting flange 182, while the jacking device 401 is kept extended to keep the blade root cross-section substantially circular.

Subsequently to the engagement device 119 having entered the respective engagement apertures, the jacking device 401 is removed from the blade root 111. This can be done by one or more persons accessing the interior of the blade root from the interior of the hub. The removed jacking device can for example be moved to the hub, and optionally through the hub and into the nacelle. The jacking device can for example be hoisted down from the hub or from the nacelle.

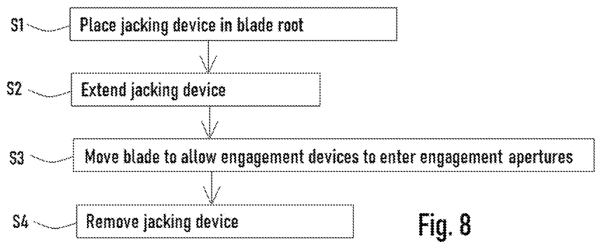

The method described with reference to FIG. 7 is illustrated in the flow chart of FIG. 8. Thus, the method comprises placing S1 in the blade root 111, before the blade is mounted to the hub, a jacking device 401 so as to extend between two opposite locations of the blade root shell 115, extending S2 the jacking device 401 to subject the blade root 111 to a jacking force acting on said two locations of the root shell 115, so as to alter the shape of the blade root as seen in a direction which is perpendicular to the root end plane, and subsequently moving S3 the blade to allow the engagement devices to at least partly enter the respective engagement apertures. The method further comprises subsequently removing S4 the jacking device 401 from the blade root 111.

As will be understood by those skilled in the present field of art, numerous changes and modifications may be made to the above described and other embodiments of the present invention, without departing from its scope as defined in the appending claims.

1. A method for mounting a wind turbine rotor blade to a hub,
the blade comprising a blade root comprising a root shell forming a tubular shape of the blade root, the blade root forming an open blade root end defining an imaginary root end plane (REP) at which the root shell terminates,
wherein for mounting the blade to the hub, one of the blade root and the hub comprises a plurality of protruding engagement devices, and the other of the blade root and the hub forms a plurality of engagement apertures each arranged to receive a respective of the engagement devices,
characterised by placing in the blade root, before the blade is mounted to the hub, a jacking device so as to extend between two opposite locations of the blade root shell,
extending the jacking device to subject the blade root to a jacking force acting on said two locations of the root shell, so as to alter the shape of the blade root as seen in a direction which is perpendicular to the root end plane (REP), and
subsequent to said step of extending the jacking device, and while the jacking device is extended to subject the blade root to the jacking force, moving the blade and/or hub to allow the engagement devices to at least partly enter the respective engagement apertures.

2. A method according to claim 1, comprising, subsequent to the engagement devices having at least partly entered the respective engagement apertures, removing the jacking device from the blade root.

3. A method according to claim 1, wherein said jacking device is a first jacking device, said jacking force is a first jacking force, and said locations are first locations, the method comprising
placing in the blade root, before the blade is mounted to the hub, in addition to the first jacking device a second jacking device so as to extend between two opposite second locations of the blade root shell, and
extending the second jacking device to subject the blade root to a second jacking force acting on said two second locations of the root shell, so as to alter the shape of the blade root as seen in a direction which is perpendicular to the root end plane (REP).

4. A method according to claim 3, wherein the second jacking device is placed so that, as seen in a direction which is perpendicular to the root end plane (REP), the smallest angle between the first jacking device and the second jacking device is more than zero degrees and less than 90 degrees.

5. A method according to claim 3, wherein the second jacking device is placed so that the second jacking device is offset from the first jacking device in a direction which is perpendicular to the root end plane (REP).

6. A method according to claim 3, wherein the second jacking device is extended to subject the blade root to the second jacking force while the blade and/or hub is moved to allow the engagement devices to at least partly enter the respective engagement apertures.
